(19) United States
(12) Patent Application Publication
(10) Pub. No.: US 2010/0170893 A1
(43) Pub. Date: Jul. 8, 2010

(54) Induction Hob

(75) Inventors: Christian Breuninger, Stuttgart (DE); Albrecht Eiber, Weinstadt-Beutelsbach (DE); Martin Neumayer, Gerstetten-Dettingen (DE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: WMF WUERTTEMBERGISCHE METALLWARENFABRIK AG, Geislingen (DE)

(21) Appl. No.: 12/525,088

(22) PCT Filed: Feb. 1, 2007
(86) PCT No.: PCT/EP07/00877

§ 371 Date: Dec. 17, 2009

(51) Int. Cl. H05B 6/12

(52) U.S. Cl. 219/622

(57) ABSTRACT

An induction hob for inductively heating cookware, having an induction coil fed with high-frequency alternating current for supplying the electromagnetic heating power, and a generator device for generating the high-frequency alternating current. In order to prevent noise developing at the cookware, the present disclosure provides for smoothing or eliminating an amplitude modulation of the high-frequency alternating current which flows through the coil.

### CROSS-REFERENCE TO RELATED APPLICATION

The present application claims the benefit of priority of International Patent Application No. PCT/EP2007/000877, filed Feb. 1, 2007. The entire text of the priority application is incorporated herein by reference in its entirety.

### FIELD OF THE DISCLOSURE

The present disclosure relates to an induction hob as well as to a method for inductively heating cookware.

### BACKGROUND

Induction hobs are known from the prior art and have become increasingly important. An induction hob includes an induction coil through which a high-frequency alternating current flows. The induction frequencies normally used lie in a range of approx. 25 to 50 kHz. In the case of inductive heating, a converter normally converts the low-frequency mains current into a high-frequency alternating current. The induction coil is normally provided below a hob consisting e.g. of glass ceramics. The current-carrying induction coil generates an alternating magnetic field. The alternating magnetic field induces strong eddy currents in a ferromagnetic material (e.g. chromium steel) of a cookware, said eddy currents leading to rapid heating of the material. The eddy currents only flow in a thin surface layer of the bottom. The bottom of the induction cookware consists of a ferromagnetic layer, and, outside of the penetration depth of the eddy currents, it consists of a material having a higher thermal conductivity so as to accomplish a better (transverse) heat distribution.

Advantages of induction hobs in comparison with conventional hobs are to be seen in the very short reaction time in response to changes in the adjustment, a comparatively cool hotplate, saving of energy, in particular in the case of short cooking times, and low prices.

Nevertheless, induction hobs also entail drawbacks. One drawback is to be seen in the fact that the cookware may develop disturbing oscillations, which are within the audible frequency range and which lead to an irritating noise, i.e. humming. Up to now, it has been assumed that the eigen-frequencies of the cookware are here a decisive factor, since they may lead to large amplitudes and, consequently, to the development of loud noise. As regards the development of noise, it is necessary to differentiate between cause and effect. The cause of the noise is the excitation of the cookware by the hob, the effect manifests itself in the noise development of the cookware caused by mechanical vibrations. Measures taken at the cookware, such as a shift of the resonant frequencies, or vibration-damping measures, such as attaching an elastic band or the like to the circumference of the cookware, did not result in any significant changes.

### SUMMARY OF THE DISCLOSURE

Taking the above as a basis, it is the object of the present disclosure to provide an induction hob and a method, which reduce or eliminate the noise development of cookware on induction hobs.

According to the present disclosure, the induction hob comprises a generator device, which, in turn, comprises means for smoothing or eliminating an amplitude modulation of the high-frequency alternating current which flows through the coil. The phrase “means for smoothing or eliminating an amplitude modulation” means that, on the one hand, a generated amplitude modulation is smoothed or eliminated, or that such an amplitude modulation is not even generated when the induction hob is operated with mains current.

Tests made with the hob have shown that, although the induction coil oscillates at the high-frequency induction frequency, this oscillation is modulated with low-frequency components having a frequency of e.g. 50 Hz (e.g. the mains frequency and multiples thereof). The amplitude modulation results from the superposition of a plurality of oscillations. Hence, the amplitude-modulated alternating current comprises, in addition to the operating frequency of the respective oscillatory circuit for establishing the magnetic field, also other frequency components, e.g.

a) from an unsmoothed, pulsating “DC current” generated by a rectifier and/or

b) from the power control of the hob.

It turned out that the reaction of the cookware is not exclusively based on the high-frequency induction frequency used for generating the magnetic field, but that this reaction is conditioned by oscillation superpositions leading to the amplitude modulation which defines the envelope of the induction frequency. This envelope need not be symmetrical, but may also be oblique, and/or superimposed by additional harmonic frequencies, irregular, etc.

Due to the fact that the high-frequency alternating current according to the present disclosure is not amplitude modulated, or that the amplitude modulation of the high-frequency alternating current is smoothed or eliminated, the excitation of the cookware and, consequently, the noise emitted thereby will be reduced or prevented. It follows that noise problems can be solved easily.

The generator device can comprise an AC rectifier as well as an oscillatory circuit generator. The AC rectifier generates a DC current from the low-frequency mains current. According to a preferred embodiment of the present disclosure, the means used for smoothing or eliminating are associated with the AC rectifier such that the unsmoothed DC current generated by the AC rectifier will be smoothed. The cause for the amplitude modulation of the high-frequency alternating current is therefore eliminated, since the oscillatory circuit does not receive any low-frequency components from the power supply.

In addition, it will be advantageous when the means for smoothing or eliminating are associated with the oscillatory circuit generator.

According to the present disclosure, the oscillatory circuit generator is provided with an oscillatory circuit control, the power control being executed such that low-frequency oscillations in the oscillatory circuit are avoided. Low-frequency oscillations originating from the power control can thus be avoided in the oscillatory circuit e.g. through appropriate control algorithms. It follows that also in this case a superposition of low-frequency oscillations on the high-frequency alternating current will be avoided. However, the amplitude modulation of the high-frequency alternating current may also be smoothed or eliminated by using appropriate circuit technology in the oscillatory circuit generator. If the oscillatory circuit generator is, for example, not fed with a smoothed DC current, power control can be effected such that the amplitude fluctuations caused by an unsmoothed DC current will be compensated. This can be done e.g. by pulse width control in the oscillatory circuit.

According to an advantageous embodiment, the means for smoothing or eliminating have a smoothing factor of approx. 40% to 100%. According to an even more preferred embodiment, the smoothing factor lies in a range between 70% and 100%. When the smoothing factor is 100%, the amplitude modulation will be 0. The high-frequency alternating current will then lie between two parallel lines. If no smoothing takes place, the envelope will have periodically occurring zero point passages. If the smoothing factor is larger than 0%, periodically occurring zero point passages will not occur in the envelope, so that a substantial reduction of the humming noise can also be accomplished in this case.

According to the present disclosure, the alternating magnetic field causes the cookware to oscillate such that there will be no emission of noise or only a reduced emission of noise.

### BRIEF DESCRIPTION OF THE DRAWINGS

The present disclosure will be explained in more detail in the following, making reference to FIGS. 1 to 13, in which:

FIG. 1 shows the schematic structural design of an induction hob according to the present disclosure.

FIG. 2 schematically shows the amplitude-modulated high-frequency alternating current flowing through the induction coil of the hob according to the prior art.

FIG. 3 shows a schematic representation of the reaction of the pot in response to the amplitude-modulated alternating current.

FIG. 4 shows a graphic representation of the envelopes of a measurement of the induction signal and of the accompanying movement of the cookware.

FIG. 5 shows the spectral content of the induction excitation and of the movement of the cookware.

FIG. 6 shows a measuring arrangement for measuring the alternating magnetic field.

FIG. 6a shows a schematic representation of the envelope with a partially smoothed amplitude modulation.

FIG. 6b shows a measured envelope and the response of the pot.

FIG. 7a shows in a schematic representation the complete smoothing of the amplitude modulation.

FIG. 7b shows a measurement with full smoothing and the resultant reaction of the pot.

FIG. 8 shows schematically the amplitude of the rectified smoothed current or voltage fed to the oscillatory circuit generator as a function of time.

FIG. 9a shows schematically the unsmoothed current generated by the AC rectifier.

FIG. 9b shows the partially smoothed current fed to the oscillatory circuit generator.

FIG. 10 shows the profile of the current fed to the oscillatory circuit generator as a function of time, without the use of a rectifier.

FIG. 11 shows an embodiment of the present disclosure.

FIG. 12 shows another embodiment of the present disclosure.

FIG. 13 shows yet another embodiment of the present disclosure.

### DETAILED DESCRIPTION OF THE PREFERRED EMBODIMENT

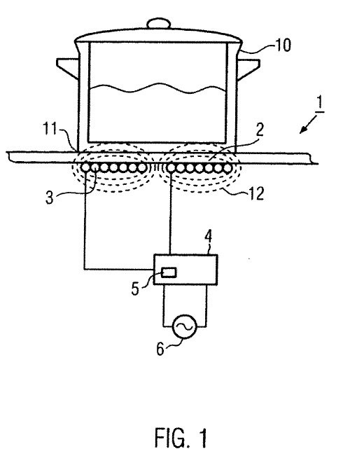

FIG. 1 shows an induction hob according to the present disclosure. The induction hob 1 comprises a cooking area 2 consisting e.g. of glass ceramics. A cooking pot 10 is here placed on the cooking area, said cooking pot 10 consisting of ferromagnetic material, e.g. chromium steel, at least in the lower, thin surface layer 11 thereof. Outside of the penetration depth of eddy currents, the cooking pot 10 may consist of a material having a higher thermal conductivity so as to accomplish a better heat distribution. An induction coil 3 is arranged below the cooking area 2. The induction coil 3 is fed with a high-frequency alternating current, so that a high-frequency alternating magnetic field 12 is generated.

The resultant alternating magnetic field 12 induces eddy currents in the lower, thin surface layer 11 of the bottom of the pot 10, said eddy currents leading to rapid heating of the material.

Further more, the induction hob according to the present disclosure comprises a generator device 4 for generating the high-frequency alternating current which is fed to the coil 3. As shown in FIGS. 11 and 12, the generator device 4 comprises e.g. an AC rectifier 20, which converts the alternating current from the mains into a direct current. The AC rectifier may e.g. also include a bridge circuit. In addition, the generator device 4 also comprises an oscillatory circuit generator 8 with an appropriate oscillatory circuit control, and means 5 for smoothing or eliminating amplitude modulation, as will be explained in more detail hereinbelow. The oscillatory circuit generator 8 generates the high-frequency alternating current in the manner known, the oscillatory circuit control 21 executing a power control for which the amplitude profile of the coil control, i.e. the power consumption of the coil can be used e.g. as a control variable and as a reference variable, respectively.

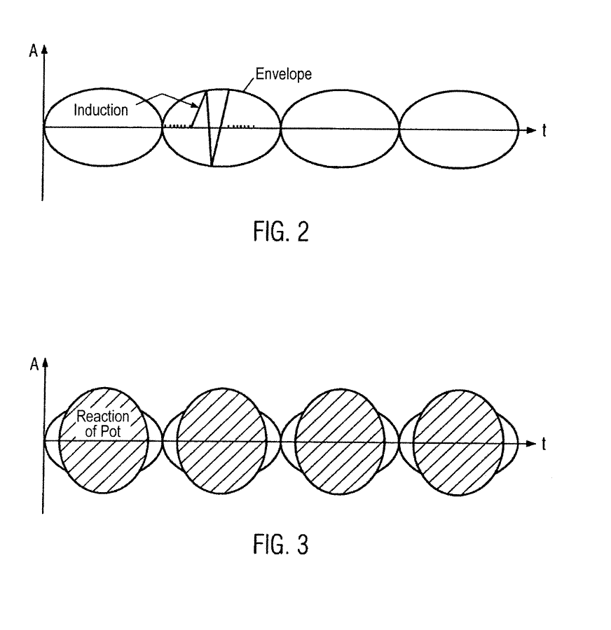

If, for example, the low-frequency mains current is converted into a high-frequency alternating current by an AC rectifier 20 and the oscillatory circuit generator 8, the induction coil will oscillate at the high-frequency, induction frequency, but the high-frequency alternating current will be amplitude modulated at a frequency of e.g. 50 Hz. FIG. 2 shows schematically the envelope of the amplitude-modulated alternating current of the induction coil according to the prior art.

The amplitude-modulated alternating current comprises, in addition to the operating frequency of the oscillatory circuit for establishing the magnetic field, also other frequency components, e.g.
a) from the smoothed DC current generated by the AC rectifier as well as
b) from a power control of the hob.

This results in the amplitude-modulated alternating current mentioned hereinbefore.

FIG. 2 shows the amplitude height as a function of time in the form of an envelope. As can clearly be seen, the amplitude of the oscillation decreases and increases periodically. The frequency of the amplitude modulation can here be e.g. 50 Hz and multiples thereof. The induction frequency, at which the coil oscillates, corresponds to the frequency of the high-frequency alternating current which flows through the coil. The induction frequency has a high frequency, e.g. >20 kHz, whereas the envelope of the current or line amplitude has a low frequency, e.g. substantially lower than 20 kHz, i.e. it enters the frequency range of the human ear.

The reaction of the cookware is not based on the induced induction frequency alone, but it is also based on the superimposed frequency, i.e. on the amplitude modulation, which forms the envelope of the periodically varying amplitudes. This envelope need not be symmetrical, but may also be oblique, and/or superimposed by additional harmonic frequencies, irregular, etc.

FIG. 3 shows the reaction of the pot in response to induction excitation. As can clearly be seen from FIG. 3, the pot, i.e. the cookware 10, is also periodically excited to oscillate in dependence upon the amplitude modulation. This periodic excitation is the cause of noise development. In FIG. 3 the reaction of the pot is shown by hatches, the amplitude-modulated alternating current corresponding to the alternating current profile shown in FIG. 2. The oscillation frequency of the cookware comprises many frequency components up to and including the induction frequency. Also the emitted sound in the audible range comprises a broad frequency spectrum.

FIG. 4 shows the envelopes of the measured alternating field 12 and of the measured movements with which the cookware 10 oscillates. The dotted lines show the oscillation behaviour of the cookware, whereas the solid lines show the envelope of the amplitude-modulated induction excitation. The oscillation response of a commercially available pot was here measured through laser Doppler vibrometry in a range of up to 70 kHz.

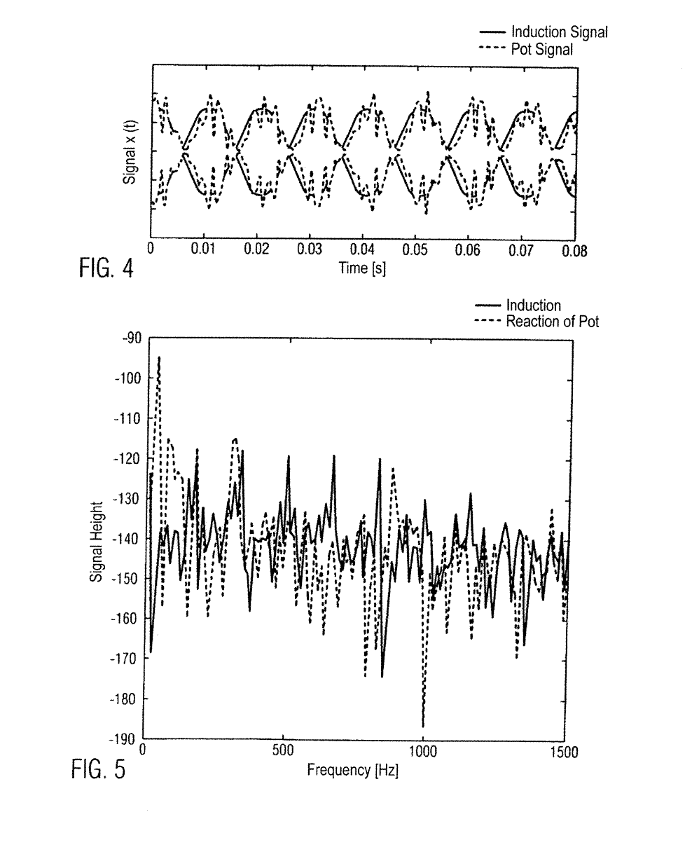

FIG. 5 shows the spectral content of the induction excitation and of the oscillations of the cookware according to FIG. 4, the induction frequencies being represented by solid lines, whereas the cookware frequencies are represented by broken lines. The oscillatory circuit frequency for generating the alternating current is not shown in this representation. The oscillation response is here shown up to a range of 1500 Hz. In order to reduce or prevent noise emission by the cookware, the amplitude modulation is smoothed or eliminated completely according to the present disclosure. The higher the smoothing factor is, the lower the excitation of the cookware will be. Hence, the present invention provides means 5 for smoothing or eliminating an amplitude modulation of the high-frequency induction excitation of the pot through the coil. This means that the amplitude modulation of the high-frequency alternating current, which flows through the induction coil 3, is smoothed or eliminated, or not even produced at all.

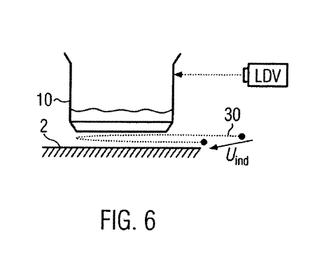

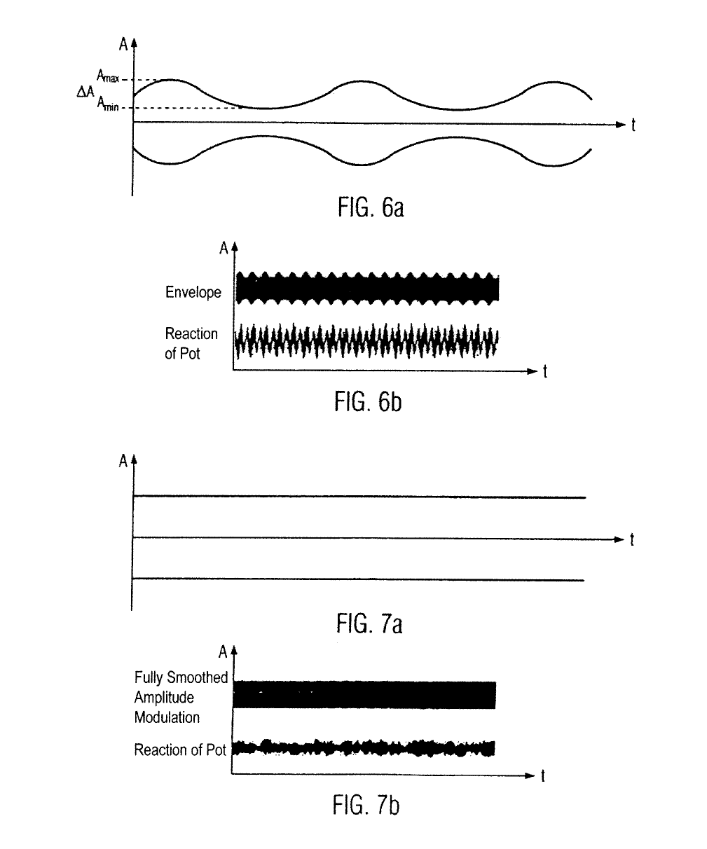

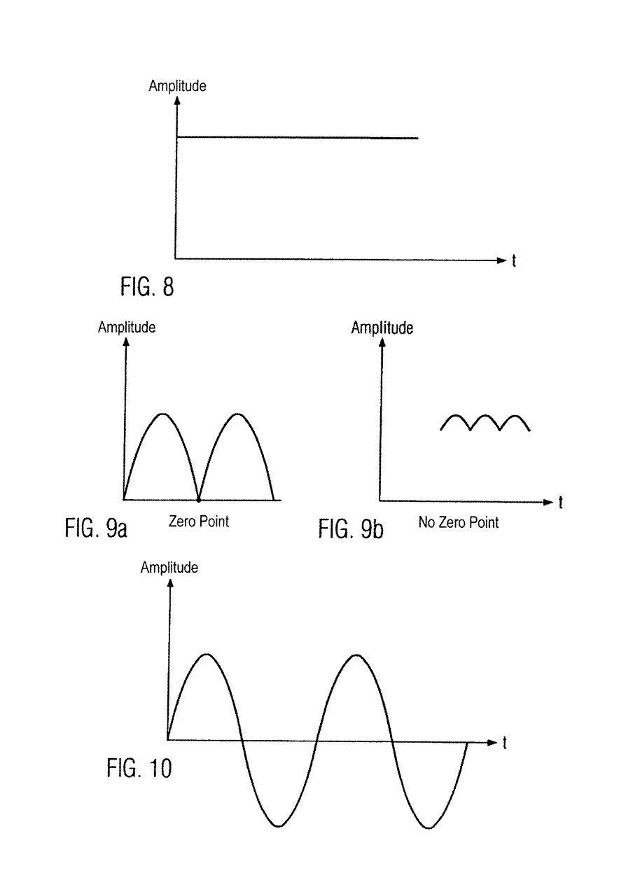

FIG. 6a shows a schematic representation of a partially smoothed envelope, e.g. of the voltage/power amplitude or of the current amplitude in the oscillatory circuit.

When the smoothing factor is 100%, as can be seen from FIG. 7a, only two parallel lines can be seen, which delimit the amplitude profile in question.

Preferably, the smoothing factor is in a range of from approx. 40 to 100%. A reduction of noise can, however, also be discerned in response to smaller smoothing factors. The smoothing factor is 0%, when the envelope has a zero point passage through the t axis. In the case of the smoothed amplitude modulation, a periodically occurring zero point passage of the envelope does not exist. The average increase and decrease of the amplitude ΔA lies, in the case of smoothing, preferably in a range of up to 60% of the maximum amplitude Aₘₐₓ, where ΔA=Aₘₐₓ−Aₘᵢₙ. Smoothing factor: (1−ΔA/Aₘₐₓ)·100.

In FIGS. 6b and 7b the alternating magnetic field was measured as a function of time. This measurement was carried out by the measuring arrangement shown in FIG. 6. In this arrangement a conductor loop 30 was incorporated between the cooking area 2 and the bottom of the pot. For the purpose of measurement, a commercially available cooking pot was used (e.g. Topstar produced by the firm of WMF). In this arrangement the conductor loop had a diameter of 7 cm. Due to the alternating magnetic field between the stove and the pot, a voltage was induced in the conductor loop, which was then measured.

The reaction of the pot is shown as a function of time through the movement with which the pot oscillates and which is measured by means of laser Doppler vibrometry. The mechanical oscillation of the pot was measured by means of the laser Doppler vibrometer (LDV), which is shown in FIG. 6 and which registers the velocity of a specific point on the pot edge in the upper area in a horizontal direction.

In the case of the measurement shown in FIG. 6b, the smoothing factor lies at approx. 70%. In FIG. 7b, the smoothing factor is 100%. As can be seen from a comparison between FIGS. 6b and 7b, the reaction of the pot occurring in the case of complete smoothing will even be weaker than in cases where the smoothing factor is 70%. However, also a smoothing factor of 70% suffices for reducing the reaction of the pot to such an extent that the emission of noise will be reduced significantly.

It follows that, according to the present disclosure, the presence of low-frequency oscillation components in the oscillatory circuit must be prevented by the means 5 used for smoothing or eliminating an amplitude modulation of the high-frequency alternating current, since, as has been explained hereinbefore, the pot will execute the mechanical oscillations analogously to the amplitude-modulated electric excitation.

According to the embodiment shown in FIG. 11, the AC rectifier has already associated therewith means 5 for smoothing the 2-phase or 3-phase alternating current in the form of a capacitor 5. In addition, also the oscillatory circuit generator 8, which also includes the oscillatory circuit control 21, can have associated therewith a further smoothing means 5, such as smoothing capacitors, filters, etc., which smooth or eliminate the amplitude modulation. Alternatively or additionally, the power control in the oscillatory circuit can also be executed in such a way that low-frequency oscillations in the oscillatory circuit will be avoided; this can be accomplished e.g. through appropriate control algorithms by using suitable software. By taking the measure shown in FIG. 11, it is possible to prevent the amplitude modulation of the high-frequency alternating current or to smooth it at least, e.g. in the way shown in FIG. 9b.

FIG. 12 represents a further possible embodiment of the present disclosure. FIG. 12 essentially corresponds to the embodiment according to FIG. 11, with the exception that the AC rectifier 20 has here not associated therewith means 5 for smoothing or eliminating the amplitude modulation. As can clearly be seen from FIG. 9a, the rectified current, which is produced by the AC rectifier 20, has periodically occurring fluctuations, which may even reach the zero point. These fluctuations are permitted. They are e.g. subsequently compensated for by including them into the power control of the oscillatory circuit, e.g. through pulse width control in the oscillatory circuit.

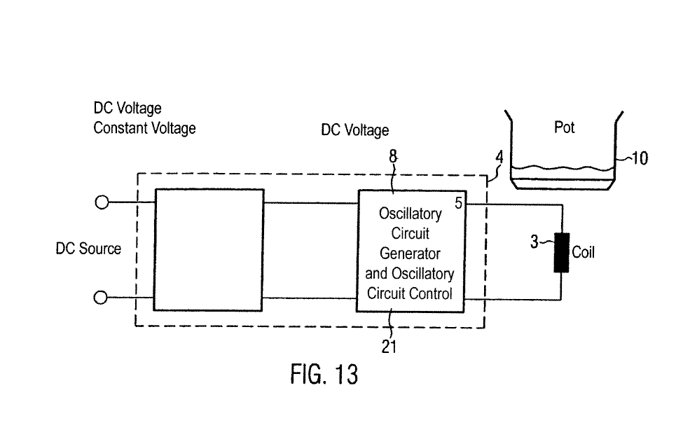

Another embodiment is shown e.g. in FIG. 13, where a DC source is used as a current source. The means 5 are here realized by the DC source. Possibly necessary means 5 are then associated with the oscillatory circuit generator and the oscillatory circuit control, respectively, so that an amplitude modulation of the high-frequency alternating current will be prevented also in this case.

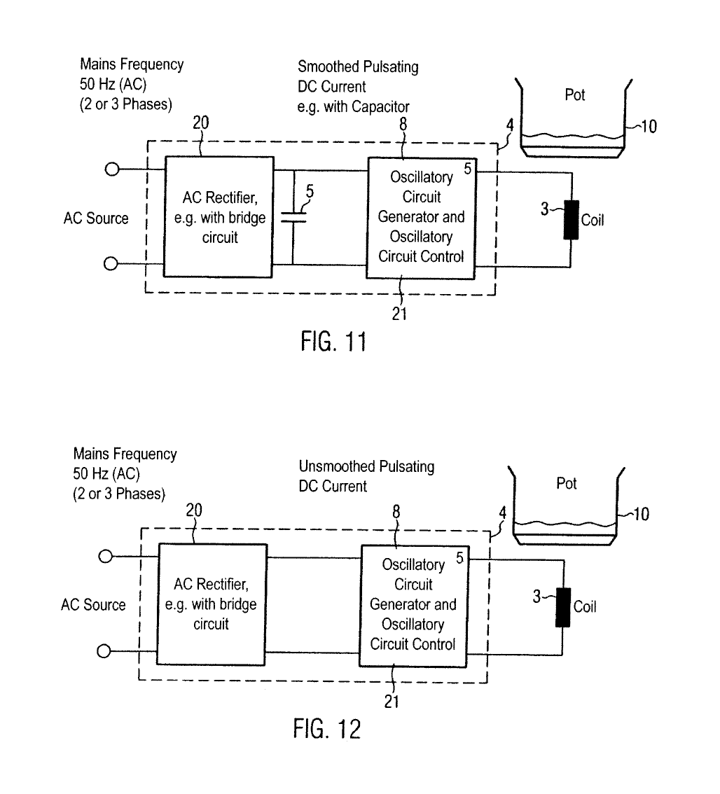

In accordance with another embodiment, it is also possible to refrain from using an AC rectifier and to use the mains voltage as a voltage source for the oscillatory circuit generator 8. FIG. 10 shows here an example for the amplitude profile of the alternating current, which is then fed to the oscillatory circuit generator 8. The compensation of the now signed fluctuations is, in the manner described hereinbefore, realized by the oscillatory circuit generator and the power control in the oscillatory circuit, by an appropriate circuit technology in the oscillatory circuit or by an appropriate control of the oscillatory circuit.

The possible embodiments shown in FIGS. 11 to 13 are only examples showing how a suitable high-frequency alternating current, which will not cause any humming noise of the cookware, can be generated. The only point of decisive importance is, however, that the generator device generates a high-frequency alternating current flowing through the coil 3, which has no amplitude modulation, or a smoothed amplitude modulation, as can be seen in FIGS. 6 and 7. It follows that, depending on the respective smoothing factor, an emission of noise by the cookware can be reduced or prevented completely.

We claim:

1. An induction hob for inductively heating cookware, comprising
an induction coil fed with high-frequency alternating current for generating the electromagnetic heating power as well as
a generator device for generating the high-frequency alternating current, and
the generator device comprising means for one of smoothing or eliminating an amplitude modulation of the high-frequency alternating current, so as to reduce a humming noise of the cookware.

2. An induction hob according to claim 1, wherein the generator device comprises an AC rectifier as well as an oscillatory circuit generator.

3. An induction hob according to claim 2, wherein the means used for one of smoothing or eliminating are associated with the AC rectifier and smooth the unsmoothed DC current generated by the AC rectifier.

4. An induction hob according to claim 2, wherein the means for one of smoothing or eliminating are associated with the oscillatory circuit generator.

5. An induction hob according to claim 1, wherein the generator device comprises an oscillatory circuit generator which is operated with mains voltage.

6. An induction hob according to claim 4, wherein the oscillatory circuit generator comprises an oscillatory circuit control, an amplitude modulation of the high-frequency alternating current being one of smoothed or eliminated by power control in the oscillatory circuit.

7. An induction hob according to claim 1, wherein the means smooth the amplitude modulation of the high-frequency alternating current with a smoothing factor of approx. 40 to 100%.

8. A method of inductively heating cookware with the aid of an induction hob comprising an induction coil fed with a high-frequency alternating current, and a generator device for generating the high-frequency alternating current, the method comprising:
feeding the generator device with current so as to generate a high-frequency alternating current,
feeding the induction coil with a high-frequency alternating current and generating an alternating magnetic field which generates eddy currents in the cookware, and
for reducing a humming noise of the cookware, generating the high-frequency alternating current in such a way that it does not exhibit amplitude modulation or that the amplitude modulation of the high-frequency alternating current is smoothed.

9. A method according to claim 8, wherein the smoothing factor lies between 40 and 100%.

10. A method according to claim 8, and, making use of the alternating magnetic field, causing the cookware to oscillate such that there will be no emission of noise or only a reduced emission of noise.

11. A method according to claim 8, wherein an oscillatory circuit generator of the generator device has supplied thereto a smoothed DC current.

12. A method according to claim 8, and executing power control of the oscillatory circuit of an oscillatory circuit generator in such a way that no low-frequency oscillations will be introduced in the oscillatory circuit.

13. A method according to 12, and executing power control in such a way that the amplitude fluctuations caused by an unsmoothed DC current fed to the oscillatory circuit will be compensated.
